(19) United States
(12) Patent Application Publication
(10) Pub. No.: US 2011/0134371 A1
(43) Pub. Date: Jun. 9, 2011

(54) ILLUMINATING DEVICE AND LIQUID CRYSTAL DISPLAY DEVICE PROVIDED WITH THE SAME

(75) Inventors: Kazuya Shimojoh, Osaka-shi (JP); Tetsuya Hamada, Osaka (JP)

(73) Assignee: SHARP KABUSHIKI KAISHA, Osaka-shi, Osaka (JP)

(21) Appl. No.: 13/057,811

(22) PCT Filed: Jun. 3, 2009
(86) PCT No.: PCT/JP2009/060138

§ 371 Date: Feb. 7, 2011

(30) Foreign Application Priority Data
Sep. 4, 2008 (JP) 2008-226999

(51) Int. Cl. G02F 1/1335; F21V 7/04

(52) U.S. Cl. 349/65; 362/612; 362/606

(57) ABSTRACT

Provided is an illuminating device wherein generation of luminance deterioration and luminance nonuniformity is suppressed. An illuminating device (10) is provided with a light guide plate (3) and an LED (6) stored inside a storing space (10a), and a power supply substrate (8) arranged outside the storing space (10a). An extracting hole (1c) is formed in a region (10b) whereupon the light guide plate (3) at a bottom section (1a) of a case member (1) is placed, and a connecting terminal (7c) of an FPC (7) is extracted to the outside from the inside of the storing space (10a) through the extracting hole (1c).

### TECHNICAL FIELD

The present invention relates to an illuminating device, and to a liquid crystal display device provided therewith.

### BACKGROUND ART

There are conventionally known illuminating devices that emit planar light, and they are used as backlight units for illuminating liquid crystal display panels in liquid crystal display devices. Such illuminating devices for liquid crystal display devices include direct-lit, side-lit, and other types.

A direct-lit illuminating device is one that has a light source arranged right behind a liquid crystal display panel. On the other hand, a side-lit illuminating device is one that has a light guide plate arranged right behind a liquid crystal display panel and that has a light source arranged to face a particular edge face of the light guide plate (see, for example, Patent Document 1 listed below). In this side-lit illuminating device, when the light source emits light, the light is introduced into the light guide plate through the particular edge face thereof; the light introduced into the light guide plate is turned into planar light, which then illuminates the liquid crystal display panel.

FIG. 4 is a diagram showing an example of a conventional side-lit illuminating device in a simplified form. FIG. 5 is a diagram illustrating the shape of a case member (a member in which a light source and a light guide plate are accommodated) used in the conventional side-lit illuminating device shown in FIG. 4. Now, with reference to FIGS. 4 and 5, the construction of the conventional side-lit illuminating device will be described.

In the conventional side-lit illuminating device, as shown in FIG. 4, a plurality of light-emitting diode elements (LEDs) 101 are used as a light source. These LEDs 101 are mounted on a single flexible printed circuit board (FPC) 102 to form a module, and are so arranged that their respective light-emission faces face a particular edge face (light-entrance face) of a light guide plate 103. On the front-face side of the light guide plate 103, there is arranged an optical sheet 104; on the rear-face side of the light guide plate 103, there is arranged a reflective sheet 105. The individual members (the LEDs 101, FPC 102, light guide plate 103, optical sheet 104, and reflective sheet 105) are fitted in a case member 106, which is formed in the shape of a box.

As shown in FIGS. 4 and 5, the case member 106 has a bottom portion 106a and side portions 106b, the latter rising vertically from a circumferential part of the former. The space inside the case member 106, located on the top-face side of the bottom portion 106a and surrounded by the side portions 106b, serves as an accommodation space. Inside this accommodation space, the above-mentioned individual members (the LEDs 101, FPC 102, light guide plate 103, optical sheet 104, and reflective sheet 105) are accommodated.

On the other hand, outside the accommodation space (on the opposite side of the bottom portion 106a of the case member 106 from the top-face side thereof), there is arranged a power supply circuit board 107, which is electrically connected to the LEDs 101, which are located inside the accommodation space. Specifically, in that side portion 106b of the case member 106 which faces the LEDs 101, an opening 106c is formed, and through this opening 106c in the case member 106, a connection terminal of the FPC 102 which is to be connected to the power supply circuit board 107 is led from inside to outside the accommodation space. Thus, by way of the FPC 102, which has the connection terminal thereof led out through the opening 106c in the case member 106, the LEDs 101, which are located inside the accommodation space, are electrically connected to the power supply circuit board 107, which is located outside the accommodation space.

### LIST OF CITATIONS

### Patent Literature

Patent Document 1: JP-A-2005-267881

### SUMMARY OF INVENTION

### Technical Problem

Inconveniently, however, with the conventional construction described above, the opening 106c formed in the case member 106 is located close to the area where the LEDs 101 are arranged; thus, when dust or the like enters the accommodation space through the opening 106c in the case member 106, the dust attaches to the light-emission face of the LEDs 101, the light-entrance face of the light guide plate 103, etc. Dust attached to the light-emission face of the LEDs 101, the light-entrance face of the light guide plate 103, etc. causes problems such as reduced brightness and uneven brightness.

The present invention has been devised to solve the problems mentioned above, and it is an object of the invention to provide an illuminating device that can suppress reduction and unevenness in brightness, and to provide a liquid crystal display device provided with such an illuminating device.

### Solution to Problem

To achieve the above object, according to a first aspect of the invention, an illuminating device includes: a case member having a bottom portion and a side portion rising from a circumferential part of the bottom portion, the space located on the top-face side of the bottom portion and surrounded by the side portion serving as an accommodation space; a light guide plate accommodated inside the accommodation space, the light guide plate at least having a light-entrance face that is a particular edge face and a light-exit face that is a face perpendicular to the light-entrance face and that faces toward an illuminated member, the light guide plate being placed on the top face of the bottom portion of the case member; a light-emitting diode element accommodated inside the accommodation space and arranged to face the light-entrance face of the light guide plate; a power supply circuit board arranged outside the accommodation space; and a connection member electrically connecting the light-emitting diode element to the power supply circuit board. Here, a passage hole is formed within the area on the bottom portion of the case member where the light guide plate is placed, the connection member runs along the bottom portion of the case member from the light-emitting diode element until a connection terminal of the connection member which is connected to the power supply circuit board reaches the passage hole, and the connection terminal of the connection member is led from inside to outside the accommodation space through the passage hole.

In this illuminating device according to the first aspect, as described above, within the area on the bottom portion of the case member where the light guide plate is placed, the passage hole is formed through which the connection terminal of the connection member (the member that electrically connects the light-emitting diode element to the power supply circuit board) which is connected to the power supply circuit board is led from inside to outside the accommodation space. This permits the passage hole to be located away from the area where the light-emitting diode element is arranged. Thus, even when dust enters the accommodation space through the passage hole, the dust is less likely to reach the area where the light-emitting diode element is arranged. In this way, it is possible to suppress attachment of dust to the light-emission face of the light-emitting diode element, the light-entrance face of the light guide plate, etc. It is thus possible to suppress reduction and unevenness in brightness.

In the above-described illuminating device according to the first aspect, it is preferable that there be further provided a reflective sheet arranged between the bottom portion of the case member and the light guide plate, and that, with the connection terminal of the connection member led out through the passage hole, the passage hole be stopped by the reflective sheet. With this construction, it is possible to suppress entry of dust into the accommodation space through the passage hole. This further reduces attachment of dust to the light-emission face of the light-emitting diode element, the light-entrance face of the light guide plate, etc., and it is thus possible to further suppress reduction and unevenness in brightness.

In the above-described illuminating device according to the first aspect, it is preferable that a groove in which the connection member is buried be formed in the bottom portion of the case member. With this construction, even when the connection member is laid along the bottom portion of the case member, the connection member does not bulge above the top face of the bottom portion of the case member. In this way, it is possible to suppress floating of the light guide plate placed on the top face of the bottom portion of the case member.

In the above-described illuminating device according to the first aspect, it is preferable that the passage hole be located near the power supply circuit board. This helps reduce the exposed part of the connection member (its part located outside the accommodation space). In this way, it is possible to suppress snagging of the connection member, and thus to make it easier to handle.

In the above-described illuminating device according to the first aspect, it is preferable that the light-emitting diode element be mounted on a flexible printed circuit board, and that part of the flexible printed circuit board serve as the connection member.

According to a second aspect of the invention, a liquid crystal display device includes: an illuminating device according to the first aspect described above; and a liquid crystal display panel illuminated with light from the illuminating device. With this construction, it is possible to suppress reduction and unevenness in brightness.

### Advantageous Effects of the Invention

As described above, according to the present invention, it is possible to easily realize an illuminating device that can suppress reduction and unevenness in brightness, and a liquid crystal display device provided with such an illuminating device.

### BRIEF DESCRIPTION OF DRAWINGS

FIG. 1 is an exploded perspective view of an illuminating device according to one embodiment of the invention.

FIG. 2 is a sectional view of the illuminating device according to one embodiment of the invention shown in FIG. 1.

FIG. 3 is a plan view of the illuminating device according to one embodiment of the invention shown in FIG. 1, as seen from a rear-face side thereof.

FIG. 4 is a diagram showing an example of a conventional side-lit illuminating device in a simplified form.

FIG. 5 is a diagram illustrating the shape of a case member (a member in which a light source and a light guide plate are accommodated) used in the conventional side-lit illuminating device shown in FIG. 4.

### DESCRIPTION OF EMBODIMENTS

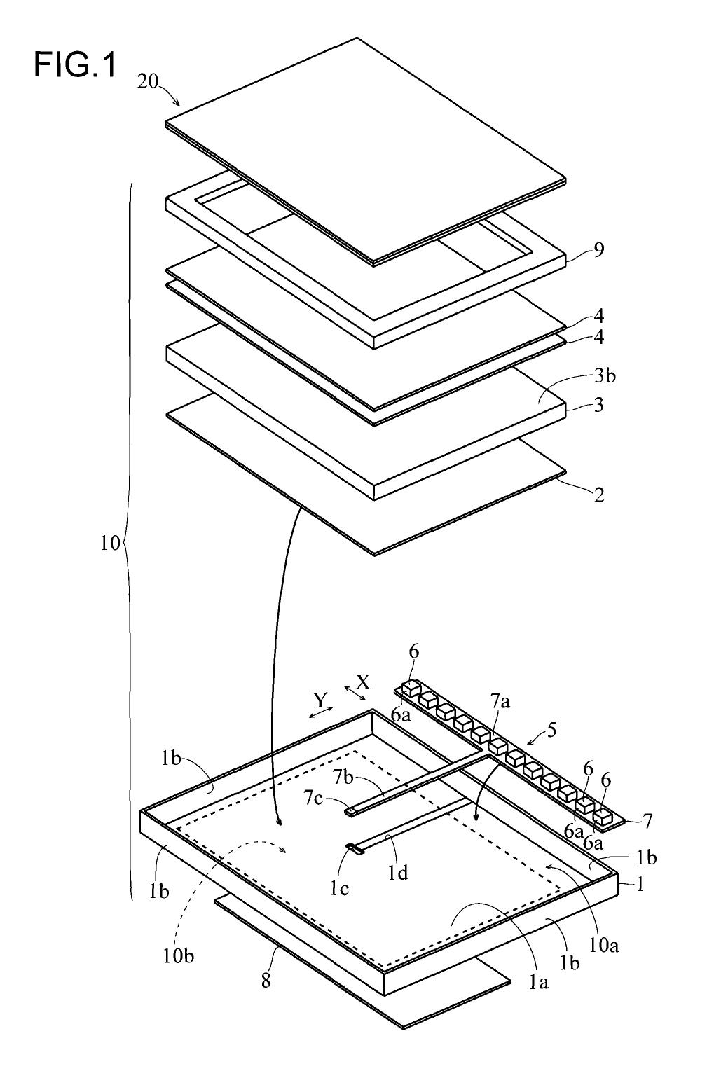

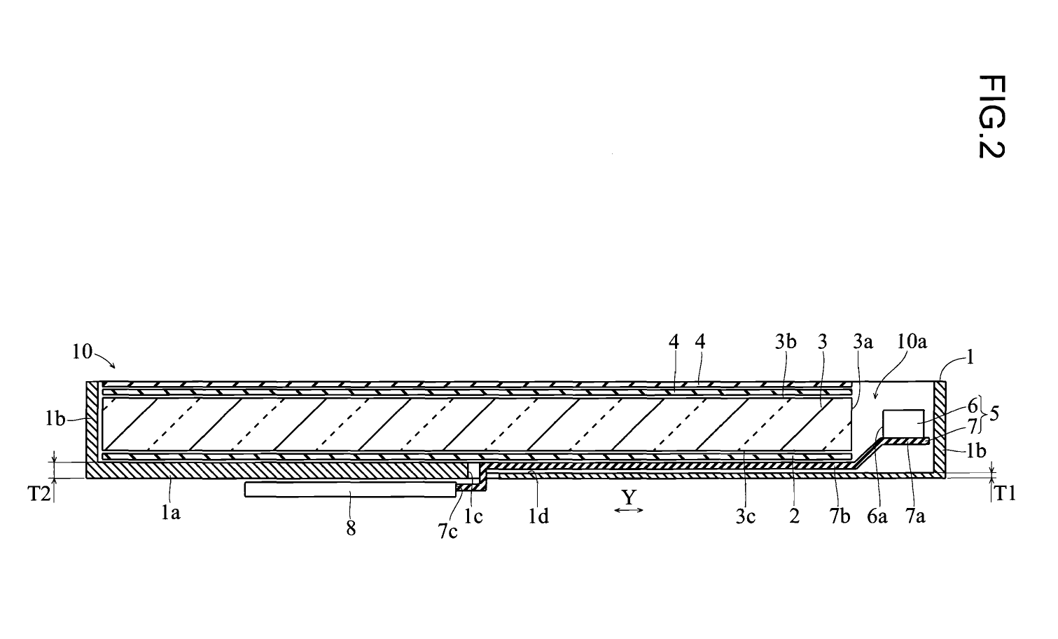

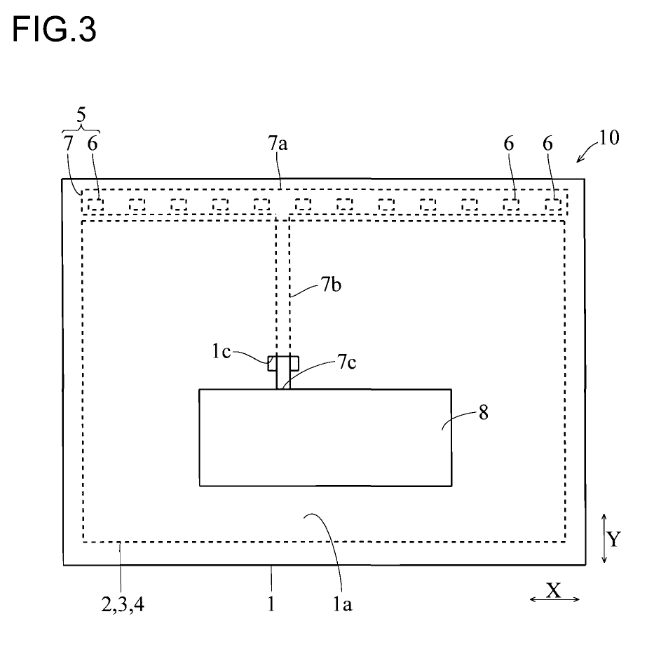

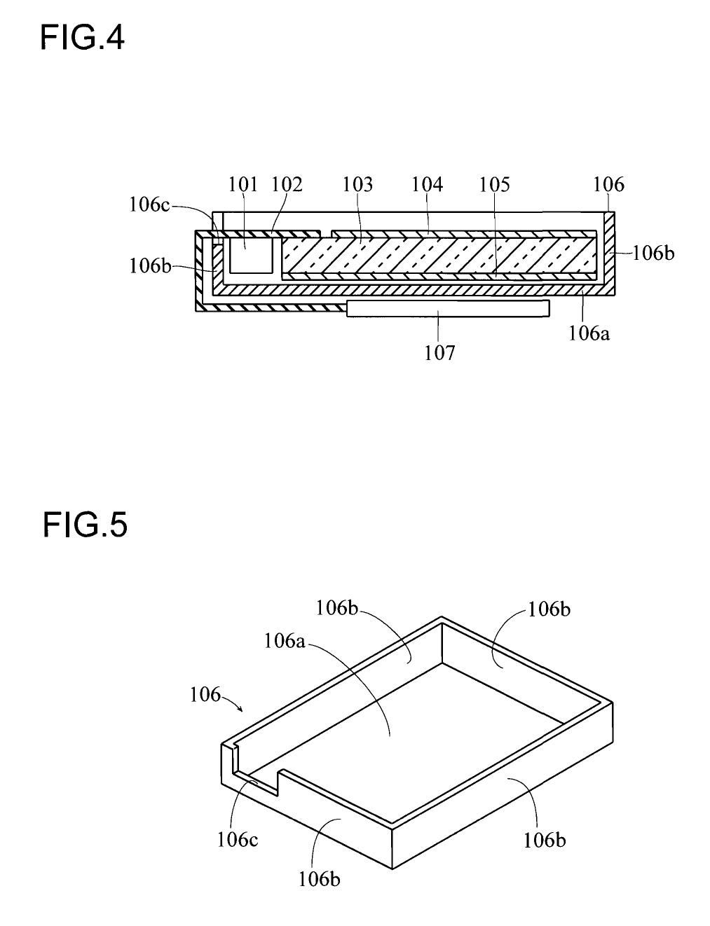

With reference to FIGS. 1 to 3, the construction of an illuminating device 10 embodying the present invention will be described below. It should be noted that, in FIG. 2, the individual members constituting the illuminating device 10 are shown with exaggerated gaps between them for easy recognition.

As shown in FIG. 1, the illuminating device 10 is used as a backlight incorporated in a liquid crystal display device, and is so structured as to produce planar light and illuminates therewith a liquid crystal display panel 20 (illuminated member) from the rear-face side thereof. The illuminating device 10 is incorporated in, for example, liquid crystal display devices for industrial use.

As shown in FIGS. 1 to 3, the illuminating device 10 is of a side-lit type, and at least includes a case member 1, a reflective sheet 2, a light guide plate 3, optical sheets 4, and a light source module 5. The reflective sheet 2, light guide plate 3, optical sheets 4, and light source module 5 are fitted in the case member 1.

The case member 1 is typically formed of sheet metal (for example, aluminum or stainless sheet) or molded of resin, and is formed in the shape of a box having an opening on the side thereof facing the liquid crystal display panel 20. Specifically, the case member 1 has a bottom portion 1a, which is rectangular in shape as seen in a plan view, and four side portions 1b, which rise vertically from a circumferential part of the bottom portion 1a. The space inside the case member 1, located on the top-face side of the bottom portion 1a (its top face being its face facing the liquid crystal display panel 20) and surrounded by the four side portions 1b serves as an accommodation space 10a. Inside this accommodation space 10a, the reflective sheet 2, light guide plate 3, optical sheets 4, and light source module 5 are accommodated.

The reflective sheet 2 is placed on the top face of the bottom portion 1a of the case member 1, and covers the rear face 3c, which will be described later, of the light guide plate 3. Owing to the provision of this reflective sheet 2, any light leaking out of the light guide plate 3 through the rear face 3c thereof is reflected on the reflective sheet 2, and this permits the light that has leaked out through the rear face 3c of the light guide plate 3 to be introduced back into the light guide plate 3.

The light guide plate 3 serves to guide the light from light-emitting diode elements (LEDs) 6, which will be described later, toward the liquid crystal display panel 20, and is arranged on top of the reflective sheet 2. Thus, the light guide plate 3 is placed over the bottom portion 1a of the case member 1 with the reflective sheet 2 interposed in between.

The light guide plate 3 is formed as a transparent plate-shaped member of resin, and has four edge faces, a front face 3b, and a rear face 3c. The four edge faces include a particular edge face 3a opposite which the LEDs 6 are arranged, and the front and rear faces 3b and 3c connect to those four edge faces. The particular edge face 3a of the light guide plate 3 serves as a light-entrance face through which the light from the LEDs 6 is introduced into the light guide plate 3. The front face 3b of the light guide plate 3 is one that is perpendicular to the light-entrance face 3a thereof and that faces the liquid crystal display panel 20, and serves as a light-exit face through which the light introduced into the light guide plate 3 emanates therefrom as planar light toward the liquid crystal display panel 20. In the following description, the particular edge face 3a of the light guide plate 3 is referred to as the light-entrance face 3a, and the front face 3b of the light guide plate 3 is referred to as the light-exit face 3b.

The optical sheets 4 include a diffusive sheet, a prism sheet, etc., and are placed on top of the light-exit face 3b of the light guide plate 3. The optical sheets 4 diffuse, condense, and otherwise regulate the light emanating from the light guide plate 3 through the light-exit face 3b thereof.

The light source module 5 includes a plurality of LEDs 6 and a flexible printed circuit board (FPC) 7 on which those LEDs 6 are mounted. The LEDs 6 are arranged at predetermined intervals in X direction (the direction along the light-entrance face 3a of the light guide plate 3) in such a way that their respective light-emission faces 6a face the light-entrance face 3a of the light guide plate 3. The LEDs 6 are, via the FPC 7 on which they are mounted, electrically connected to a power supply circuit board 8 arranged outside the accommodation space 10a (on the opposite side of the bottom portion 1a of the case member 1 from the top-face side thereof, that is, on the rear-face side of the bottom portion 1a).

The FPC 7, which electrically connects the LEDs 6 to the power supply circuit board 8, is formed in a T-shape, and has as its integral parts a mounting portion 7a, on which the LEDs 6 are mounted, and a connection portion 7b, which is connected to the power supply circuit board 8. The mounting portion 7a of the FPC 7 is formed in the shape of a band extending in X direction. On the other hand, the connection portion 7b of the FPC 7 extends in Y direction (the direction perpendicular to X direction) from the mounting portion 7a, with a width smaller than that of the mounting portion 7a, and has at its tip end (its end opposite from the mounting portion 7a) a connection terminal 7c, which is connected to the power supply circuit board 8. It should be noted that the connection portion 7b of the FPC 7 is an example of a “connection member” according to the invention.

Here, in this embodiment, within the area 10b (the area surrounded by a broken line in FIG. 1) on the bottom portion 1a of the case member 1 where the light guide plate 3 is placed, a passage hole 1c is formed that penetrates the bottom portion 1a of the case member 1. The connection portion 7b of the FPC 7 runs along the bottom portion 1a of the case member 1 from the LEDs 6 until the connection terminal 7c reaches the passage hole 1c in the case member 1. The connection terminal 7c of the connection portion 7b of the FPC 7 is then led from inside to outside the accommodation space 10a (from the top-face side of the bottom portion 1a of the case member 1 to the rear-face side thereof) through the passage hole 1c in the case member 1.

The passage hole 1c in the case member 1 is formed at or near the center of the bottom portion 1a of the case member 1, and is located close to the power supply circuit board 8. To avoid the effect of heat from the LEDs 6, the power supply circuit board 8 is arranged as far away as possible from the LEDs 6. Accordingly, located close to the power supply circuit board 8, the passage hole 1c in the case member 1 is located away from the LEDs 6.

Moreover, in this embodiment, in a predetermined part of the bottom portion 1a of the case member 1, a groove 1d is formed in which the connection portion 7b of the FPC 7 is buried. Specifically, the bottom portion 1a of the case member 1 has, in the predetermined part thereof where the groove 1d is formed, a thickness T1 that is smaller than its thickness T2 in the other part thereof. With the connection portion 7b of the FPC 7 buried in the groove 1d in the case member 1, and with the connection terminal 7c of the connection portion 7b of the FPC 7 led out through the passage hole 1c in the case member 1, the passage hole 1c in the case member 1 is stopped by the reflective sheet 2.

Moreover, with the reflective sheet 2, light guide plate 3, optical sheets 4, and light source module 5 accommodated in the accommodation space 10a, a frame 9 in the shape of a frame is fitted in the opening in the case member 1. The frame part of the frame 9 presses the optical sheets 4 from above.

In this embodiment, as described above, within the area 10b on the bottom portion 1a of the case member 1 where the light guide plate 3 is placed, the passage hole 1c is formed through which the connection terminal 7c of the connection portion 7b of the FPC 7 is led from inside to outside the accommodation space 10a. This permits the passage hole 1c in the case member 1 to be located away from the area where the LEDs 6 are arranged. Thus, even when dust enters the accommodation space 10a through the passage hole 1c in the case member 1, the dust is less likely to reach the area where the LEDs 6 are arranged. In this way, it is possible to suppress attachment of dust to the light-emission face 6a of the LEDs 6, the light-entrance face 3a of the light guide plate 3, etc. It is thus possible to suppress reduction and unevenness in brightness.

Moreover, in this embodiment, as described above, with the connection terminal 7c of the connection portion 7b of the FPC 7 led out through the passage hole 1c in the case member 1, the passage hole 1c in the case member 1 is stopped by the reflective sheet 2. This makes it possible to suppress entry of dust into the accommodation space 10a through the passage hole 1c in the case member 1. This further reduces attachment of dust to the light-emission face 6a of the LEDs 6, the light-entrance face 3a of the light guide plate 3, etc., and it is thus possible to further suppress reduction and unevenness in brightness.

Moreover, in this embodiment, as described above, the groove 1d in which the connection portion 7b of the FPC 7 is buried is formed in the bottom portion 1a of the case member 1. Thus, even when the connection portion 7b of the FPC 7 is laid along the bottom portion 1a of the case member 1, the connection portion 7b of the FPC 7 does not bulge above the top face of the bottom portion 1a of the case member 1. In this way, it is possible to suppress floating of the light guide plate 3 (reflective sheet 2) placed on the top face of the bottom portion 1a of the case member 1.

Moreover, in this embodiment, as described above, the passage hole 1c in the case member 1 is provided close to the power supply circuit board 8. This helps reduce the exposed part of the connection portion 7b. In this way, it is possible to suppress snagging of the connection portion 7b of the FPC 7, and thus to make it easier to handle.

It should be understood that the embodiment described above is in every aspect illustrative but not restrictive. The scope of the invention is defined not by the above description of the embodiment but by the appended claims, and many modifications and variations are possible within the sense and scope equivalent to those of the claims.

### LIST OF REFERENCE SIGNS

1 Case member
1a Bottom portion
1b Side portion
1c Passage hole
1d Groove
2 Reflective sheet
3 Light guide plate
3a Light-entrance face
3b Light-exit face
6 LED (light-emitting diode element)
6a Light-emission face
7 FPC (flexible printed circuit board)
7a Mounting portion
7b Connection portion (connection member)
7c Connection terminal
8 Power supply circuit board
10 Illuminating device
10a Accommodation space
10b Area
20 Liquid crystal display panel (illuminated member)

1. An illuminating device comprising:
a case member having a bottom portion and a side portion rising from a circumferential part of the bottom portion, a space located on a top-face side of the bottom portion and surrounded by the side portion serving as an accommodation space;
a light guide plate accommodated inside the accommodation space, the light guide plate at least having a light-entrance face that is a particular edge face and a light-exit face that is a face perpendicular to the light-entrance face and that faces toward an illuminated member, the light guide plate being placed on a top face of the bottom portion of the case member;
a light-emitting diode element accommodated inside the accommodation space and arranged to face the light-entrance face of the light guide plate;
a power supply circuit board arranged outside the accommodation space; and
a connection member electrically connecting the light-emitting diode element to the power supply circuit board,
wherein
a passage hole is formed within an area on the bottom portion of the case member where the light guide plate is placed,
the connection member runs along the bottom portion of the case member from the light-emitting diode element until a connection terminal of the connection member which is connected to the power supply circuit board reaches the passage hole, and
the connection terminal of the connection member is led from inside to outside the accommodation space through the passage hole.

2. The illuminating device according to claim 1, further comprising:
a reflective sheet arranged between the bottom portion of the case member and the light guide plate,
wherein
with the connection terminal of the connection member led out through the passage hole, the passage hole is stopped by the reflective sheet.

3. The illuminating device according to claim 1, wherein
a groove in which the connection member is buried is formed in the bottom portion of the case member.

4. The illuminating device according to claim 1, wherein
the passage hole is located near the power supply circuit board.

5. The illuminating device according to claim 1, wherein
the light-emitting diode element is mounted on a flexible printed circuit board, and
part of the flexible printed circuit board serves as the connection member.

6. A liquid crystal display device comprising:
the illuminating device according to claim 1; and
a liquid crystal display panel illuminated with light from the illuminating device.

7. A liquid crystal display device comprising:
the illuminating device according to claim 2; and
a liquid crystal display panel illuminated with light from the illuminating device.

8. A liquid crystal display device comprising:
the illuminating device according to claim 3; and
a liquid crystal display panel illuminated with light from the illuminating device.

9. A liquid crystal display device comprising:
the illuminating device according to claim 4; and
a liquid crystal display panel illuminated with light from the illuminating device.

10. A liquid crystal display device comprising:
the illuminating device according to claim 5; and
a liquid crystal display panel illuminated with light from the illuminating device.
